(19) United States
(12) Patent Application Publication
(10) Pub. No.: US 2021/0382969 A1
(43) Pub. Date: Dec. 9, 2021

(54) BIOMETRICS AUTHENTICATION METHOD AND APPARATUS USING IN-VEHICLE MULTI CAMERA

(71) Applicant: LG Electronics Inc., Seoul (KR)

(72) Inventor: Minsick PARK, Seoul (KR)

(21) Appl. No.: 16/490,525

(22) PCT Filed: Jul. 1, 2019
(86) PCT No.: PCT/KR2019/007977

§ 371 Date: Aug. 30, 2019

(51) Int. Cl. G06F 21/32; H04N 5/232; B60R 11/04

(52) U.S. Cl. CPC G06F 21/32; H04N 5/23238; G06K 2009/00395; B60R 11/04; H04N 5/23206

(57) ABSTRACT

A method of performing biometrics authentication based on an image required for biometrics. The method includes setting a region of interest for a user in a vehicle based on an image photographed by a first camera in a vehicle system, setting the region of interest for a face and/or a hand of the user, adjusting a view angle of a second camera based on the region of interest, acquiring an image for the biometrics for the user using the second camera, and performing the biometrics authentication based on the image. Implementations may reduce costs of implementing an in-vehicle biometrics authentication system. At least one of an autonomous vehicle, a user terminal, and a server may be linked with an artificial intelligence module, a drone (unmanned aerial vehicle (UAV)), a robot, an augmented reality (AR) device, a virtual reality (VR) device, devices related to 5G services and the like.

### TECHNICAL FIELD

The present invention relates to a vehicle system, and more particularly, to a biometrics authentication method and apparatus using an in-vehicle multi camera.

### BACKGROUND ART

An automobile may be classified into an internal combustion engine vehicle, an external combustion engine vehicle, a gas turbine vehicle, an electric vehicle, and the like according to a type of prime mover used.

An autonomous vehicle refers to a vehicle that can drive on one's own without an operation of a driver or a passenger, and automated vehicle & highway systems refers to a system that monitors and controls such autonomous vehicle to drive on one's own.

### DISCLOSURE

### Technical Problem

The present invention provides a method of implementing a low-cost biometrics authentication system using a plurality of cameras in a vehicle system.

The present invention also provides a method of performing biometrics authentication by tracking a movement even in a situation where a user in a vehicle moves freely.

The technical objects of the present invention are not limited to the above-mentioned technical objects, and other technical objects that are not mentioned will be clearly understood by those skilled in the art through the following descriptions.

### Technical Solution

In an aspect, a method of performing biometrics authentication in a vehicle system includes: setting a region of interest for a user in a vehicle based on an image photographed by a first camera; adjusting a view angle of a second camera based on the region of interest; acquiring an image required for biometrics for the user in the vehicle using the second camera; and performing the biometrics authentication based on the image required for the biometrics, in which the region of interest is set for at least one of a face and a hand of the user in the vehicle.

In the method according to the embodiment of the present invention, the image required for the biometrics may correspond to an image for an iris.

In the method according to the embodiment of the present invention, the first camera may correspond to a wide angle camera which supports a field of view (FOV) of 130° or more, and the second camera may correspond to a high-resolution narrow angle camera which supports a resolution of ultra-high definition (UHD) or more.

In the method according to the embodiment of the present invention, information on a user subjected to the biometrics authentication may be provided to at least any one of a display system, a cargo system, a seat system, and a payment system included in the vehicle system.

In the method according to the embodiment of the present invention, the method may further include: acquiring another image required for the biometrics for the user in the vehicle using the second camera; and performing additional biometrics authentication based on the another image.

In the method according to the embodiment of the present invention, the another image may correspond to an image for a vein of the hand of the user in the vehicle.

In the method according to the embodiment of the present invention, the additional biometrics authentication may be performed when payment request signaling is received.

In the method according to the embodiment of the present invention, when a result of the biometrics authentication is the same as a result of the additional biometrics authentication, payment for the payment request may be completed.

In another aspect, an apparatus for performing biometrics authentication in a vehicle system includes: a method which stores data; an imaging device which includes a first camera and a second camera for photographing an image; and a processor which is functionally connected to the memory and the imaging device, in which the processor sets a region of interest for a user in a vehicle based on an image photographed by a first camera, adjusts a view angle of the second camera based on the region of interest, acquires an image required for biometrics for the user in the vehicle using the second camera, and performs the biometrics authentication based on the image required for the biometrics, and the region of interest is set for at least one of a face and a hand of the user in the vehicle.

In the apparatus according to the embodiment of the present invention, the first camera may correspond to a wide angle camera which supports a field of view (FOV) of 130° or more, and the second camera may correspond to a high-resolution narrow angle camera which supports a resolution of ultra-high definition (UHD) or more.

In the apparatus according to the embodiment of the present invention, the processor may acquire another image required for biometrics for the user in the vehicle using the second camera, and perform additional biometrics authentication based on the another image.

In the apparatus according to the embodiment of the present invention, the image required for the biometrics may correspond to an image for an iris, and the another image may correspond to an image for a vein of the hand of the user in the vehicle.

In the apparatus according to the embodiment of the present invention, the additional biometrics authentication may be performed when payment request signaling is received.

In the apparatus according to the embodiment of the present invention, when a result of the biometrics authentication is the same as a result of the additional biometrics authentication, the processor may perform control to complete payment for the payment request.

In the apparatus according to the embodiment of the present invention, the apparatus may communicate with at least one of a mobile terminal, a network, and an autonomous vehicle other than the apparatus.

### Advantageous Effects

The method of performing biometrics authentication in the vehicle system of the present invention has been described with reference to the example applied to the iris recognition and the vein matching, but can be applied to various authentication methods and vehicle systems.

According to an embodiment of the present invention, there is an effect that can reduce costs of configuring the biometrics authentication system through the biometrics authentication method using a in-vehicle multi camera.

In addition, according to an embodiment of the present invention, it is possible to recognize biometrics for a plurality of passengers and biometrics without the special operation of the passengers.

Effects which can be achieved by the present invention are not limited to the above-mentioned effects. That is, other objects that are not mentioned may be obviously understood by those skilled in the art to which the present invention pertains from the following description.

### DESCRIPTION OF DRAWINGS

FIG. 1 is a block configuration diagram of a wireless communication system to which methods proposed herein can be applied.

FIG. 2 is a diagram illustrating an example of a signal transmission/reception method in the wireless communication system.

FIG. 3 is a diagram illustrating an example of a basic operation of an autonomous vehicle and a 5G network in a 5G communication system.

FIG. 4 is a diagram illustrating an example of a vehicle-to-vehicle basic operation using 5G communication.

FIG. 5 is a diagram illustrating a vehicle according to an embodiment of the present invention.

FIG. 6 is a control block diagram of a vehicle according to an embodiment of the present invention.

FIG. 7 is a control block diagram of an autonomous vehicle according to an embodiment of the present invention.

FIG. 8 is a flowchart of a signal of an autonomous vehicle according to an embodiment of the present invention.

FIG. 9 is a diagram illustrating an inside of a vehicle according to an embodiment of the present invention.

FIG. 10 is a block diagram referred to describe a vehicle cabin system according to an embodiment of the present invention.

FIG. 11 is a diagram referred to for describing a use scenario of a user according to an embodiment of the present invention.

FIG. 12 is a diagram illustrating an example of performing in-vehicle biometrics authentication to which the present invention can be applied.

FIG. 13 is a diagram illustrating an example of an operation and a signaling procedure between a camera and a processor when biometrics authentication is performed in a vehicle system to which the present invention can be applied.

FIG. 14 is a diagram illustrating an example of an apparatus configuration to which the present invention can be applied.

FIG. 15 is a diagram illustrating an example of an operation flowchart of an apparatus to which the present invention can be applied.

### MODE FOR INVENTION

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent path loss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.
The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

FIG. 3 shows an example of basic operations of an autonomous vehicle and a 5G network in a 5G communication system. For convenience of explanation, only the 5G communication system will be described as a reference, but it is not intended to limit the technical spirit of the present invention.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (side-link communication transmission mode 3) or indirectly (side-link communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical side-link control channel (PSCCH) is a 5G physical channel for scheduling of transmission of specific information a physical side-link shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

Driving

(1) Exterior of Vehicle

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include side-link communication based on LTE and/or side-link communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

FIG. 8 is a diagram showing a signal flow in an autonomous vehicle according to an embodiment of the present invention.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 253.

Cabin

FIG. 9 is a diagram showing the interior of the vehicle according to an embodiment of the present disclosure. FIG. 10 is a block diagram referred to in description of a cabin system for a vehicle according to an embodiment of the present disclosure.

(1) Components of Cabin

Referring to FIGS. 9 and 10, a cabin system 300 for a vehicle (hereinafter, a cabin system) can be defined as a convenience system for a user who uses the vehicle 10. The cabin system 300 can be explained as a high-end system including a display system 350, a cargo system 355, a seat system 360 and a payment system 365. The cabin system 300 may include a main controller 370, a memory 340, an interface 380, a power supply 390, an input device 310, an imaging device 320, a communication device 330, the display system 350, the cargo system 355, the seat system 360 and the payment system 365. The cabin system 300 may further include components in addition to the components described in this specification or may not include some of the components described in this specification according to embodiments.

1) Main Controller

The main controller 370 can be electrically connected to the input device 310, the communication device 330, the display system 350, the cargo system 355, the seat system 360 and the payment system 365 and exchange signals with these components. The main controller 370 can control the input device 310, the communication device 330, the display system 350, the cargo system 355, the seat system 360 and the payment system 365. The main controller 370 may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The main controller 370 may be configured as at least one sub-controller. The main controller 370 may include a plurality of sub-controllers according to an embodiment. The plurality of sub-controllers may individually control the devices and systems included in the cabin system 300. The devices and systems included in the cabin system 300 may be grouped by function or grouped on the basis of seats on which a user can sit.

The main controller 370 may include at least one processor 371. Although FIG. 6 illustrates the main controller 370 including a single processor 371, the main controller 371 may include a plurality of processors. The processor 371 may be categorized as one of the above-described sub-controllers.

The processor 371 can receive signals, information or data from a user terminal through the communication device 330. The user terminal can transmit signals, information or data to the cabin system 300.

The processor 371 can identify a user on the basis of image data received from at least one of an internal camera and an external camera included in the imaging device. The processor 371 can identify a user by applying an image processing algorithm to the image data. For example, the processor 371 may identify a user by comparing information received from the user terminal with the image data. For example, the information may include at least one of route information, body information, fellow passenger information, baggage information, position information, preferred content information, preferred food information, disability information and use history information of a user.

The main controller 370 may include an artificial intelligence (AI) agent 372. The AI agent 372 can perform machine learning on the basis of data acquired through the input device 310. The AI agent 371 can control at least one of the display system 350, the cargo system 355, the seat system 360 and the payment system 365 on the basis of machine learning results.

2) Essential Components

The memory 340 is electrically connected to the main controller 370. The memory 340 can store basic data about units, control data for operation control of units, and input/output data. The memory 340 can store data processed in the main controller 370. Hardware-wise, the memory 340 may be configured using at least one of a ROM, a RAM, an EPROM, a flash drive and a hard drive. The memory 340 can store various types of data for the overall operation of the cabin system 300, such as a program for processing or control of the main controller 370. The memory 340 may be integrated with the main controller 370.

The interface 380 can exchange signals with at least one electronic device included in the vehicle 10 in a wired or wireless manner. The interface 380 may be configured using at least one of a communication module, a terminal, a pin, a cable, a port, a circuit, an element and a device.

The power supply 390 can provide power to the cabin system 300. The power supply 390 can be provided with power from a power source (e.g., a battery) included in the vehicle 10 and supply the power to each unit of the cabin system 300. The power supply 390 can operate according to a control signal supplied from the main controller 370. For example, the power supply 390 may be implemented as a switched-mode power supply (SMPS).

The cabin system 300 may include at least one printed circuit board (PCB). The main controller 370, the memory 340, the interface 380 and the power supply 390 may be mounted on at least one PCB.

3) Input Device

The input device 310 can receive a user input. The input device 310 can convert the user input into an electrical signal. The electrical signal converted by the input device 310 can be converted into a control signal and provided to at least one of the display system 350, the cargo system 355, the seat system 360 and the payment system 365. The main controller 370 or at least one processor included in the cabin system 300 can generate a control signal based on an electrical signal received from the input device 310.

The input device 310 may include at least one of a touch input unit, a gesture input unit, a mechanical input unit and a voice input unit. The touch input unit can convert a user's touch input into an electrical signal. The touch input unit may include at least one touch sensor for detecting a user's touch input. According to an embodiment, the touch input unit can realize a touch screen by integrating with at least one display included in the display system 350. Such a touch screen can provide both an input interface and an output interface between the cabin system 300 and a user. The gesture input unit can convert a user's gesture input into an electrical signal. The gesture input unit may include at least one of an infrared sensor and an image sensor for detecting a user's gesture input. According to an embodiment, the gesture input unit can detect a user's three-dimensional gesture input. To this end, the gesture input unit may include a plurality of light output units for outputting infrared light or a plurality of image sensors. The gesture input unit may detect a user's three-dimensional gesture input using TOF (Time of Flight), structured light or disparity. The mechanical input unit can convert a user's physical input (e.g., press or rotation) through a mechanical device into an electrical signal. The mechanical input unit may include at least one of a button, a dome switch, a jog wheel and a jog switch. Meanwhile, the gesture input unit and the mechanical input unit may be integrated. For example, the input device 310 may include a jog dial device that includes a gesture sensor and is formed such that it can be inserted/ejected into/from a part of a surrounding structure (e.g., at least one of a seat, an armrest and a door). When the jog dial device is parallel to the surrounding structure, the jog dial device can serve as a gesture input unit. When the jog dial device is protruded from the surrounding structure, the jog dial device can serve as a mechanical input unit. The voice input unit can convert a user's voice input into an electrical signal. The voice input unit may include at least one microphone. The voice input unit may include a beam forming MIC.

4) Imaging Device

The imaging device 320 can include at least one camera. The imaging device 320 may include at least one of an internal camera and an external camera. The internal camera can capture an image of the inside of the cabin. The external camera can capture an image of the outside of the vehicle. The internal camera can acquire an image of the inside of the cabin. The imaging device 320 may include at least one internal camera. It is desirable that the imaging device 320 include as many cameras as the number of passengers who can ride in the vehicle. The imaging device 320 can provide an image acquired by the internal camera. The main controller 370 or at least one processor included in the cabin system 300 can detect a motion of a user on the basis of an image acquired by the internal camera, generate a signal on the basis of the detected motion and provide the signal to at least one of the display system 350, the cargo system 355, the seat system 360 and the payment system 365. The external camera can acquire an image of the outside of the vehicle. The imaging device 320 may include at least one external camera. It is desirable that the imaging device 320 include as many cameras as the number of doors through which passengers ride in the vehicle. The imaging device 320 can provide an image acquired by the external camera. The main controller 370 or at least one processor included in the cabin system 300 can acquire user information on the basis of the image acquired by the external camera. The main controller 370 or at least one processor included in the cabin system 300 can authenticate a user or acquire body information (e.g., height information, weight information, etc.), fellow passenger information and baggage information of a user on the basis of the user information.

5) Communication Device

The communication device 330 can exchange signals with external devices in a wireless manner. The communication device 330 can exchange signals with external devices through a network or directly exchange signals with external devices. External devices may include at least one of a server, a mobile terminal and another vehicle. The communication device 330 may exchange signals with at least one user terminal. The communication device 330 may include an antenna and at least one of an RF circuit and an RF element which can implement at least one communication protocol in order to perform communication. According to an embodiment, the communication device 330 may use a plurality of communication protocols. The communication device 330 may switch communication protocols according to a distance to a mobile terminal.

For example, the communication device can exchange signals with external devices on the basis of C-V2X (Cellular V2X). For example, C-V2X may include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

6) Display System

The display system 350 can display graphic objects. The display system 350 may include at least one display device. For example, the display system 350 may include a first display device 410 for common use and a second display device 420 for individual use.

6.1) Common Display Device

The first display device 410 may include at least one display 411 which outputs visual content. The display 411 included in the first display device 410 may be realized by at least one of a flat panel display, a curved display, a rollable display and a flexible display. For example, the first display device 410 may include a first display 411 which is positioned behind a seat and formed to be inserted/ejected into/from the cabin, and a first mechanism for moving the first display 411. The first display 411 may be disposed such that it can be inserted/ejected into/from a slot formed in a seat main frame. According to an embodiment, the first display device 410 may further include a flexible area control mechanism. The first display may be formed to be flexible and a flexible area of the first display may be controlled according to user position. For example, the first display device 410 may be disposed on the ceiling inside the cabin and include a second display formed to be rollable and a second mechanism for rolling or unrolling the second display. The second display may be formed such that images can be displayed on both sides thereof. For example, the first display device 410 may be disposed on the ceiling inside the cabin and include a third display formed to be flexible and a third mechanism for bending or unbending the third display. According to an embodiment, the display system 350 may further include at least one processor which provides a control signal to at least one of the first display device 410 and the second display device 420. The processor included in the display system 350 can generate a control signal on the basis of a signal received from at last one of the main controller 370, the input device 310, the imaging device 320 and the communication device 330.

A display area of a display included in the first display device 410 may be divided into a first area 411a and a second area 411b. The first area 411a can be defined as a content display area. For example, the first area 411 may display at least one of graphic objects corresponding to can display entertainment content (e.g., movies, sports, shopping, food, etc.), video conferences, food menu and augmented reality screens. The first area 411a may display graphic objects corresponding to traveling situation information of the vehicle 10. The traveling situation information may include at least one of object information outside the vehicle, navigation information and vehicle state information. The object information outside the vehicle may include information on presence or absence of an object, positional information of an object, information on a distance between the vehicle and an object, and information on a relative speed of the vehicle with respect to an object. The navigation information may include at least one of map information, information on a set destination, route information according to setting of the destination, information on various objects on a route, lane information and information on the current position of the vehicle. The vehicle state information may include vehicle attitude information, vehicle speed information, vehicle tilt information, vehicle weight information, vehicle orientation information, vehicle battery information, vehicle fuel information, vehicle tire pressure information, vehicle steering information, vehicle indoor temperature information, vehicle indoor humidity information, pedal position information, vehicle engine temperature information, etc. The second area 411b can be defined as a user interface area. For example, the second area 411b may display an AI agent screen. The second area 411b may be located in an area defined by a seat frame according to an embodiment. In this case, a user can view content displayed in the second area 411b between seats. The first display device 410 may provide hologram content according to an embodiment. For example, the first display device 410 may provide hologram content for each of a plurality of users such that only a user who requests the content can view the content.

6.2) Display Device for Individual Use

The second display device 420 can include at least one display 421. The second display device 420 can provide the display 421 at a position at which only an individual passenger can view display content. For example, the display 421 may be disposed on an armrest of a seat. The second display device 420 can display graphic objects corresponding to personal information of a user. The second display device 420 may include as many displays 421 as the number of passengers who can ride in the vehicle. The second display device 420 can realize a touch screen by forming a layered structure along with a touch sensor or being integrated with the touch sensor. The second display device 420 can display graphic objects for receiving a user input for seat adjustment or indoor temperature adjustment.

7) Cargo System

The cargo system 355 can provide items to a user at the request of the user. The cargo system 355 can operate on the basis of an electrical signal generated by the input device 310 or the communication device 330. The cargo system 355 can include a cargo box. The cargo box can be hidden in a part under a seat. When an electrical signal based on user input is received, the cargo box can be exposed to the cabin. The user can select a necessary item from articles loaded in the cargo box. The cargo system 355 may include a sliding moving mechanism and an item pop-up mechanism in order to expose the cargo box according to user input. The cargo system 355 may include a plurality of cargo boxes in order to provide various types of items. A weight sensor for determining whether each item is provided may be embedded in the cargo box.

8) Seat System

The seat system 360 can provide a user customized seat to a user. The seat system 360 can operate on the basis of an electrical signal generated by the input device 310 or the communication device 330. The seat system 360 can adjust at least one element of a seat on the basis of acquired user body data. The seat system 360 may include a user detection sensor (e.g., a pressure sensor) for determining whether a user sits on a seat. The seat system 360 may include a plurality of seats on which a plurality of users can sit. One of the plurality of seats can be disposed to face at least another seat. At least two users can set facing each other inside the cabin.

9) Payment System

The payment system 365 can provide a payment service to a user. The payment system 365 can operate on the basis of an electrical signal generated by the input device 310 or the communication device 330. The payment system 365 can calculate a price for at least one service used by the user and request the user to pay the calculated price.

(2) Autonomous Vehicle Usage Scenarios

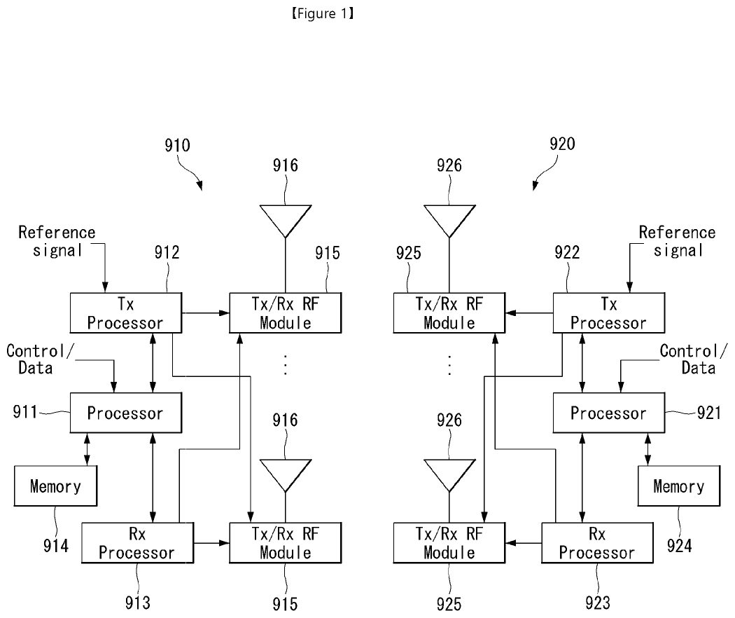

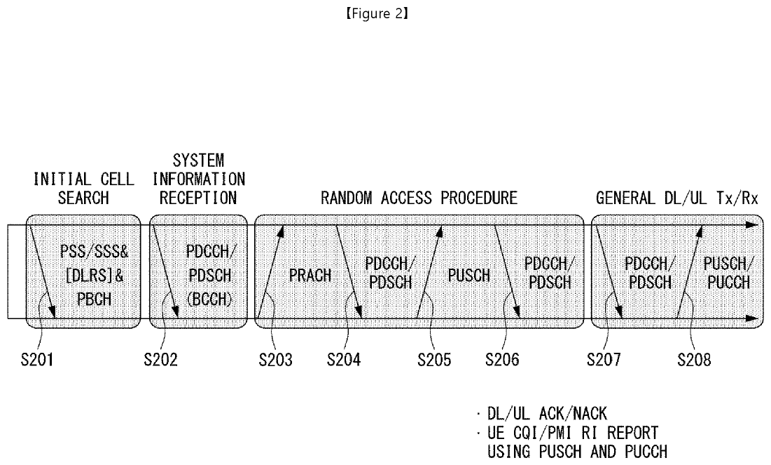

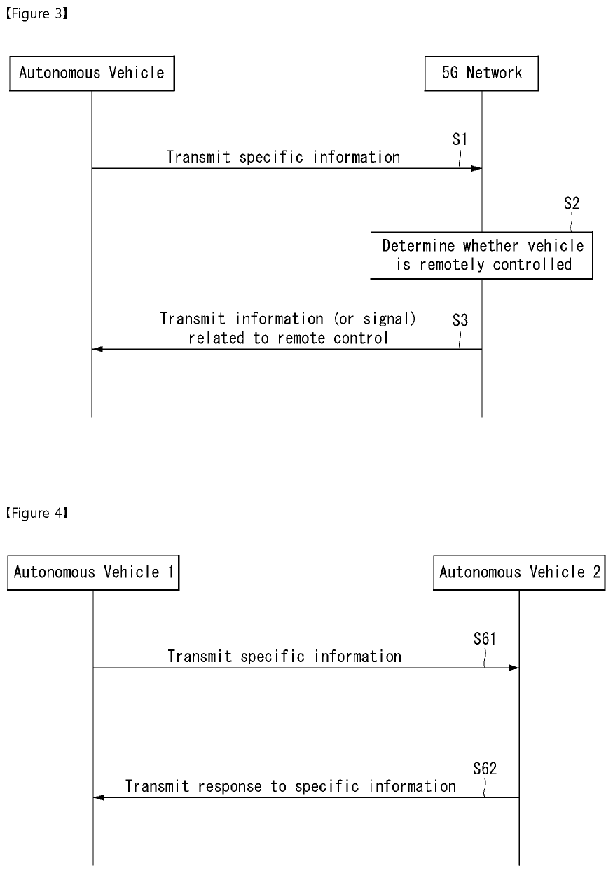

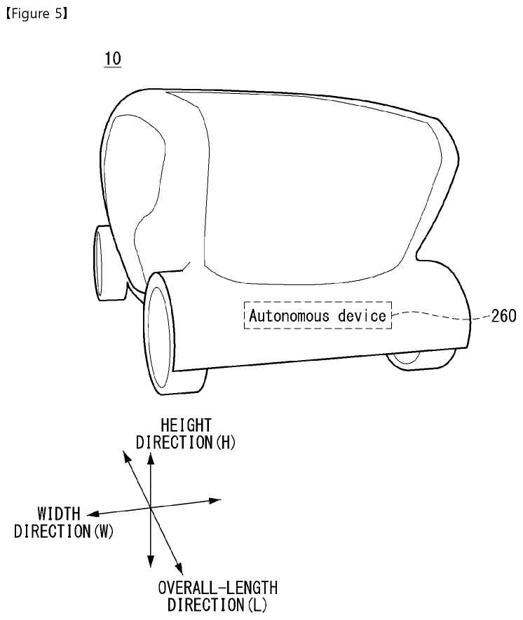

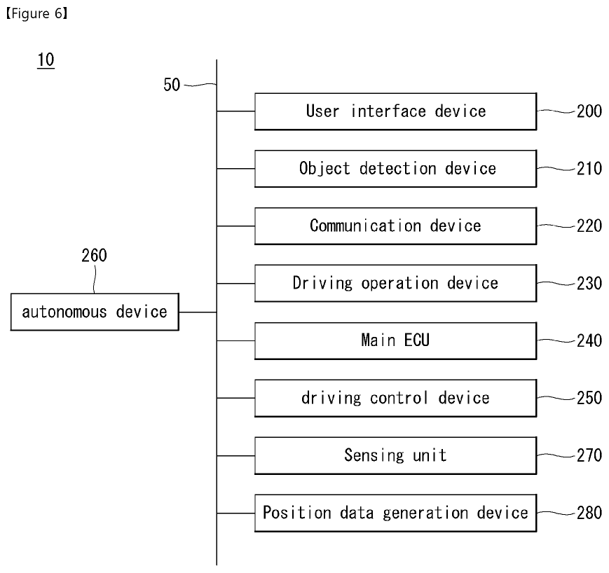

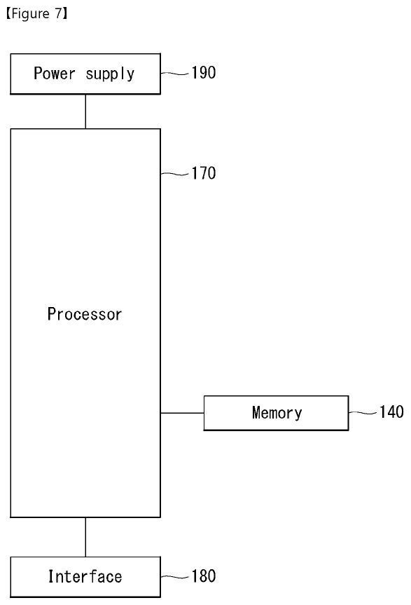

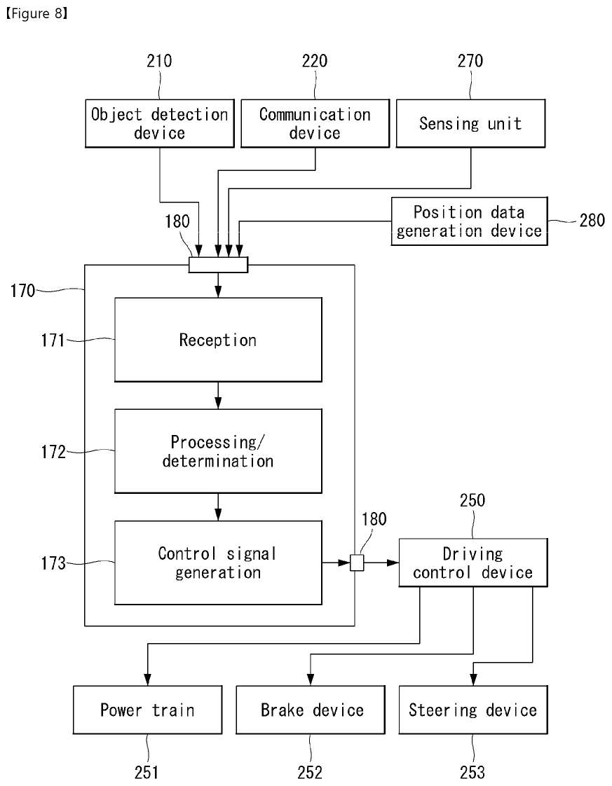

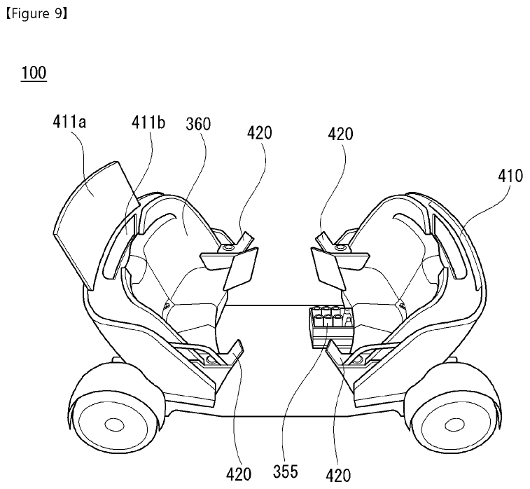

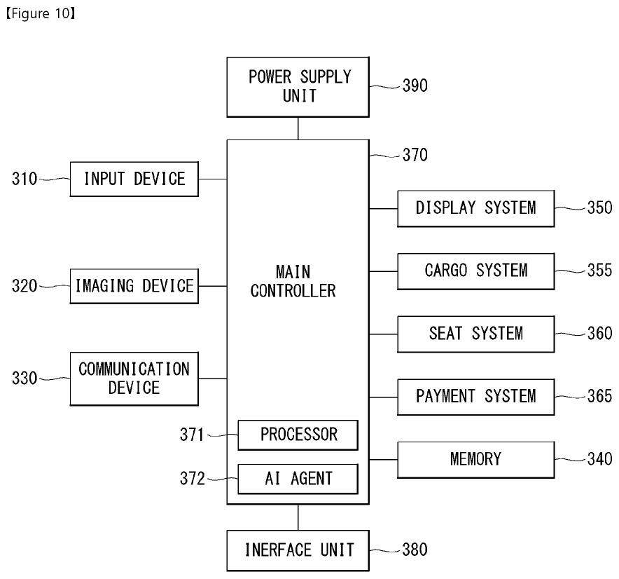

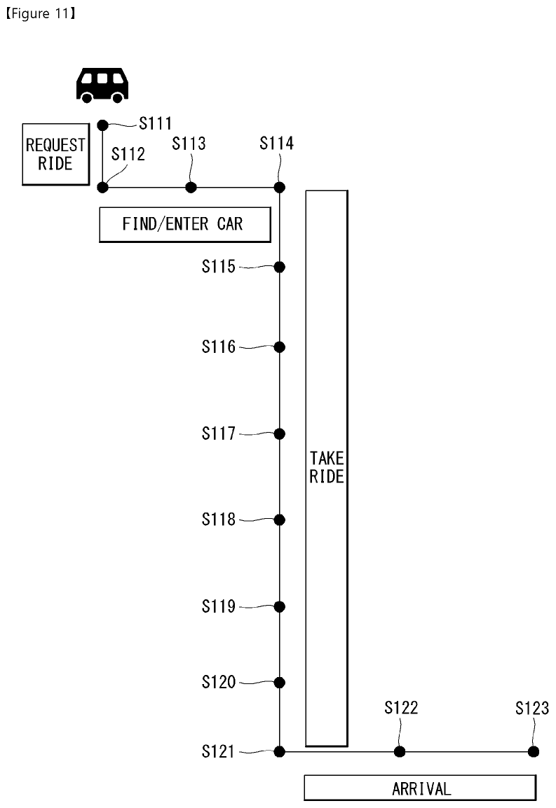

FIG. 11 is a diagram referred to in description of a usage scenario of a user according to an embodiment of the present disclosure.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

C-V2X

A wireless communication system is a multiple access system that supports communication with multiple users by sharing available system resources (for example, bandwidth, transmit power or the like). Examples of the multiple access system include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system, a multi carrier frequency division multiple access (MC-FDMA) system and the like.

Sidelink refers to a communication method of establishing a direct link between user equipments (UEs) and directly exchanging voice, data or the like between terminals without passing through a base station (BS). The sidelink is considered as one way to solve a burden of the base station due to rapidly increasing data traffic.

Vehicle-to-everything (V2X) refers to a communication technology that exchanges information with other vehicles, pedestrians, things on which infrastructure is built and the like through wired/wireless communication. The V2X can be classified into four types such as vehicle-to-vehicle (V2V), vehicle-to-infrastructure (V2I), vehicle-to-network (V2N), and vehicle-to-pedestrian (V2P). V2X communication may be provided via a PC5 interface and/or a Uu interface.

Meanwhile, as more communication devices require larger communication capacities, there is a need for improved mobile broadband communication as compared to the existing radio access technology (RAT). Accordingly, a communication system considering a service or a terminal that is sensitive to reliability and latency is being discussed. Next-generation radio access technologies that consider the improved mobile broadband communication, massive MTC, ultra-reliable and low latency communication (URLLC) and the like may be referred to as new radio access technology (RAT) or new radio (NR). The vehicle-to-everything (V2X) communication may be supported even in NR

The following technologies may be used for various wireless communication systems such as code division multiple access (CDMA), frequency division multiple access (FDMA), time division multiple access (TDMA), orthogonal frequency division multiple access (OFDMA), and single carrier frequency division multiple access (SC-FDMA). The CDMA may be implemented by wireless technologies such as universal terrestrial radio access (UTRA) and CDMA2000. The TDMA may be implemented by wireless technologies such as global system for mobile communications (GSM)/general packet radio service (GPRS)/enhanced data rates for GSM evolution (EDGE). The OFDMA may be implemented by wireless technologies such as institute of electrical and electronics engineers (IEEE) 802.11 (Wi-Fi), IEEE 802.16 (WiMAX), IEEE 802-20, and evolved UTRA (E-UTRA). IEEE 802.16m is an evolution of IEEE 802.16e and provides backward compatibility with systems based on IEEE 802.16e. The UTRA is part of a universal mobile telecommunications system (UMTS). 3rd generation partnership project (3GPP) long term evolution (LTE) is part of evolved UMTS (E-UMTS) using evolved-UMTS terrestrial radio access (E-UTRA), and employs OFDMA on downlink and SC-FDMA on uplink. LTE-advanced (LTE-A) is the evolution of the 3GPP LTE.

The 5G NR is a successor technology of the LTE-A, and is a new clean-slate type mobile communication system having characteristics such as high performance, low latency, and high availability. The 5G NR can take advantage of all available spectral resources such as a low frequency band below 1 GHz, an intermediate frequency band from 1 GHz to 10 GHz, and a high frequency (millimeter wave) band above 24 GHz.

For clarity of description, the following description focuses on the LTE-A or the 5G NR, but the technical idea of the present invention is not limited thereto.

A method of recognizing and authenticating a user may be required to provide an optimal user experience in an autonomous system, including the above-described examples of an autonomous vehicle use scenario. A biometrics technology may be considered as one of the methods of recognizing and authenticating a user. The biometrics technology refers to a technology that recognizes a user based on one or more unique physical and behavioral characteristics of the user. The biometrics technology may be replaced by various terms such as biometrics authentication, biological authentication, biostatistics, biological recognition, biometrics, and biometry. Examples of the physical characteristics used in the biometrics technology include a fingerprint, an iris, a face, and a vein and the like, and examples of the behavioral characteristics used in the biometrics technology include voice, signature and the like.

For example, face recognition may be basically performed by extracting and selecting a feature of a target and then classifying the target. A face recognition algorithm may identify face features by extracting marks or features from an image of a subject's face. The face recognition algorithm may analyze a relative position, size, and/or shape of eyes, nose, cheekbones, and jaw. The features can be extracted from the analysis, and used to find another image (target) with features that match the features.

A three-dimensional face recognition technology may use a 3D sensor to capture information on the shape of the face. This information can be used to identify features of a facial surface, such as contours of eyes, nose, and jaw. Three-dimensional data points of the face can greatly improve the accuracy of the face recognition. The 3D sensor can project structured light onto a face and capture other parts of spectrum through a plurality of image sensors, thereby performing the three-dimensional face recognition. Alternatively, 3D images can be captured using three tracking cameras indicating different angles. One camera points to a front of the subject, a second camera points to one side, a third camera points to the opposite side, and all these cameras work together to track a subject's face in real time and recognize a face.

A skin texture analysis technology, which uses visual details of a skin, may mathematically express unique lines, patterns, and spots which are visible on a person's skin and may be operated in the same way as facial recognition. A patch called a skin print is photographed, and algorithms can be used to express the patch mathematically and measurably to distinguish skin lines, pores, actual skin texture and the like.

As another example, a biometrics technology using an iris may be applied. The iris is a tissue around a pupil, and represents a donut-shaped red fiber that controls the amount of light entering eyes by controlling a size of a pupil through contraction and relaxation. The iris has a unique pattern that varies with a radius and an angular direction. Iris recognition is an automated biometrics method using a mathematical pattern recognition technology on images of two or one human eye, and enables complex patterns to be unique, stable, and viewed from a certain distance. The iris recognition can use a video camera technology with near-infrared illumination to acquire detailed, complex structured iris patterns visible from the outside. These patterns can be encoded into digital templates by mathematical and statistical algorithms and searched by a matcher engine in a registered template databases to identify users.

In another example, vein matching (vascular matching) is a biometrics technology using analysis of distribution patterns of blood vessels, particularly, veins, that can be visible on the surface of the skin. Users may be identified based on unique patterns of veins by scanning blood vessels such as fingers, a back of a hand, and palms.

In addition, users may be identified using fingerprints, long fingers (for example, palm width, finger length and the like), retinal scan (for example, recognize patterns of capillaries in an eye's retina), a shape of ears (for example, shape of an earlobe) and the like.

In the conventional in-vehicle image-based biometrics method, a recognition target region is limited, and when it may be difficult to perform the recognition when a user moves, and it is expensive to configure the biometrics system. In the present specification, in implementing a user authentication system based on an in-vehicle biometrics technology in a vehicle system, there is provided a low-cost biometrics solution and apparatus capable of performing biometrics using a wide angle camera and a high-resolution narrow angle camera even under the environment that a user freely moves. Hereinafter, description will be made based on iris recognition and vein matching, but this is only for convenience of description and does not limit the technical spirit of the present invention. Therefore, the present invention can also be applied to other biometrics technologies based on images photographed from an in-vehicle camera.

As described above, a cabin system 300 may include an imaging device 320. The imaging device 320 may include an internal camera which can photograph an image in the cabin. A method of performing biometrics for a user in a vehicle using an internal camera may be considered. The internal camera may include a wide angle camera (for example, first camera) capable of photographing the inside of the cabin as a whole in order to perform biometrics authentication, and a high-resolution narrow angle camera (for example, second camera) for photographing an image required for the biometrics authentication.

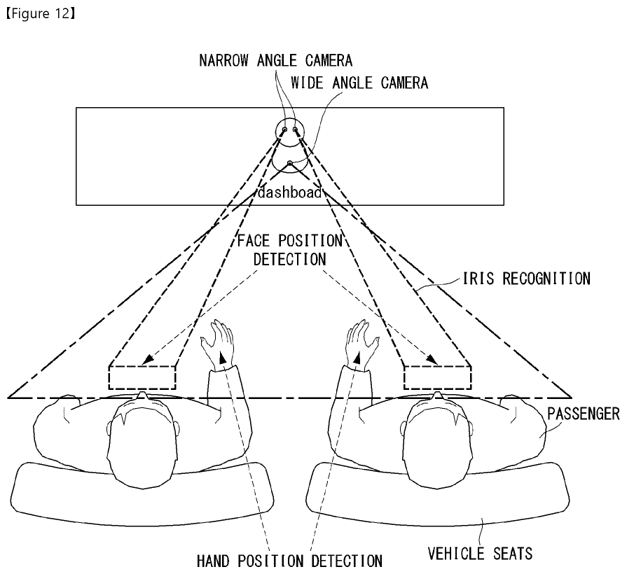

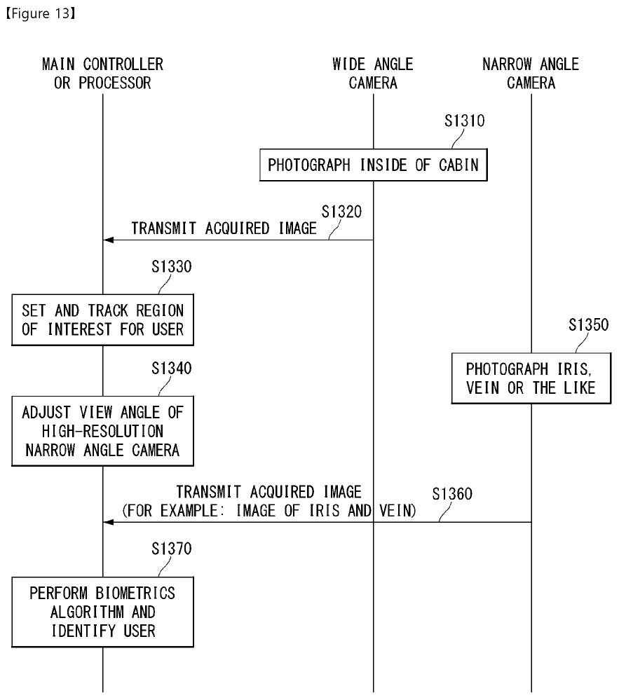

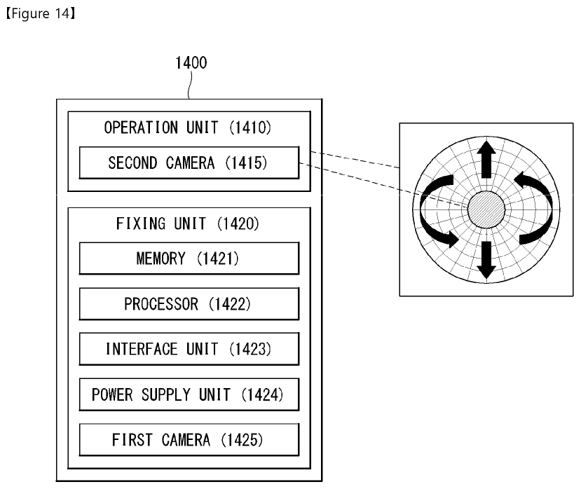

FIG. 12 illustrates an example of performing biometrics authentication in a vehicle system proposed by the present invention. FIG. 13 illustrates an example of an operation and a signaling procedure between a processor and an internal camera performing biometrics authentication in the autonomous system proposed by the present invention. FIGS. 12 and 13 are merely examples for understanding the present invention, and do not limit the technical spirit of the present invention.

Referring to FIGS. 12 and 13, information on a user in a vehicle may be acquired using the internal camera of the vehicle. The information on the user in the vehicle may be acquired by a wide angle camera among internal cameras. The wide angle camera may acquire an image by photographing the inside of the cabin as a whole (S1310). The wide angle camera can support performance that field of view (FOV) is 130° or more and resolution is 1920×720 (FHD) or more in order to photograph the inside of the cabin as a whole. The wide angle camera may be configured in a form in which an RGB sensor and a depth sensor are combined to recognize a depth of a target (for example, user) to be photographed. The wide angle camera may be fixedly installed at a specific position of a vehicle in order to photograph the inside of the vehicle as a whole. For example, the wide angle camera may be located at a center of a dashboard of the vehicle.

The wide angle camera may provide the acquired image to at least one processor included in the main controller 370 or the cabin system 300 (S1320). At least one processor included in the main controller 370 or the cabin system 300 may recognize the number of users in the vehicle from the image acquired by the wide angle camera. In addition, a region of interest may be set for each user from the image acquired by the wide angle camera (S1330).

For example, the least one processor included in the main controller 370 or the cabin system 300 may form a skeleton model for each user from an image acquired by the wide angle camera, and divide positions of regions (for example, face, hand and the like) including a biometrics target of a user and set the divided positions as the region of interest. Specifically, the number, positions, position information of each joint of each user can be extracted from the image obtained by photographing the inside of the cabin as a whole by the wide angle camera, and one skeleton model may be formed from the position information of each of the joints thus extracted. The position of the region including the biometrics targets such as a face and a hand may be divided based on the skeleton model formed and set as the region of interest. Also, the change in the region set as the region of interest may be tracked by recognizing the movement of the user based on the movement of the skeleton model, thereby updating the setting of the region of interest. The region of interest set at the positions of the user's face, hand and the like may be extracted at a size of 100×100 pixels or more.

The region of interest may be simultaneously set for the user's face and hand. Alternatively, when a region of interest is set for a face for iris recognition, and then a message requiring a higher security level such as a payment request is received, a region of interest may be additionally set for a hand to perform additional authentication.

In addition, a region of interest may be set only for a driver, may be set for a user located in a front seat of a vehicle, or may be set for all users in the vehicle.

The biometrics for the user recognition may be performed based on the set region of interest. An image for performing biometrics may be photographed by a high-resolution narrow angle camera among the cameras in the cabin. At least one processor included in the main controller 370 or the cabin system 300 may adjust a view angle of the high-resolution narrow angle camera according to the position of the region of interest (S1340). Therefore, the high-resolution narrow angle camera needs to be located in an operation unit to photograph the user by tracking the region of interest that changes based on the movement of the user. Alternatively, the high-resolution narrow angle camera itself may rotate and move. The high-resolution narrow angle camera can support high-resolution because it need to be able to photograph human eyes (for example, iris), veins, and the like. The high-resolution narrow angle camera may be configured as a stereo camera to simultaneously perform the iris recognition for both eyes. The high-resolution narrow angle camera may acquire an image for biometrics according to the region of interest and the adjusted view angle (S1350).

For example, the position of the face of the user who is in the vehicle may be set as the region of interest from the image acquired by the wide angle camera. At least one processor included in the main controller 370 or the cabin system 300 can move the high-solution narrow angle camera itself or the operation unit (or mechanical unit) including the high-resolution narrow angle camera according to the movement of the face based on the region of interest, thereby controlling the view angle of the high-resolution narrow angle camera. The iris of the user can be photographed by adjusting the view angle of the high-resolution narrow angle camera to the positions of eyes in the face. In this case, the minimum size of the eye may be extracted at a resolution of 160×160 pixels or more.

The high-resolution narrow angle camera may provide the acquired image to at least one processor included in the main controller 370 or the cabin system 300 (S1360). At least one processor included in the main controller 370 or the cabin system 300 may perform a biometrics algorithm and perform a user authentication (or identification) and personalization operation, based on the image (S1370). That is, a user may be identified through an iris recognition algorithm, a vein authentication algorithm or the like.

The user information identified through the above-mentioned biometrics may be provided to at least one of the display system 350, the cargo system 355, the seat system 360, and the payment system 365 which are included in the cabin system 300. Each system may provide an optimized service to a user based on user information identified through biometrics.

In one example, the information identified through the biometrics may be transmitted to the seat system 360 to adjust at least one element of a sheet that matches a user. Specifically, when the user information identified through the biometrics corresponds to a driver, in-vehicle devices, such as a seat height and angle for a driver may be provided to be customized to the driver.

As another example, the information identified through the biometrics authentication may be transmitted to the display system 350 to provide content that matches a user. Specifically, multimedia (for example, music playback) data preferred by the user may be set, and a connection (for example, BT, voice recognition and the like) between the personal device of the user and the vehicle may be provided.

As another example, when a user in a vehicle is a new user who does not exist in a user pool stored in the existing database, information on the new user can be transmitted to the owner or registered owner of the vehicle via the vehicle network (for example, V2X). The owner or registered owner of the vehicle can control whether the new user can be authorized to use the vehicle. Alternatively, a new user's access notification may be transmitted to a security system connected to the vehicle network.

As another example, the information identified through the biometrics authentication may be transmitted to the payment system 365 to provide a payment service to a user. Specifically, the payment system 365 may request a user to calculate a price for at least one service used by the user, and to pay the calculated price.

On the other hand, when a high level of security such as providing the payment service is required, user authentication security can be enhanced by performing additional biometrics authentication in addition to the iris authentication method described above. Hereinafter, a user authentication method through the vein authentication in addition to the iris recognition will be described.

As described above, the region of interest may be set for the user in the vehicle based on the image acquired by the wide angle camera. That is, the position of the user's face, hand or the like may be set as the region of interest. When an enhanced user authentication method such as in-vehicle payment is required, security can be enhanced by additionally performing the vein authentication using the high-resolution narrow angle camera.

In detail, the position of the hand may be set as the region of interest based on the image acquired by the wide angle camera. When at least one processor included in the main controller 370 or the cabin system 300 receives payment request signaling, at least one processor included in the main controller 370 or the cabin system 300 may adjust the view angle of the high-resolution narrow angle camera to the position of the hand by controlling the camera itself or the operation unit including the high-resolution narrow angle camera. The high-resolution narrow angle camera may photograph veins of a finger, a back of a hand, a palm and the like and transmit the corresponding image to at least one processor included in the main controller 370 or the cabin system 300. For more accurate photographing, a message requesting a user to make his/her hand approach the camera or spread out his/her palm may be displayed through an in-vehicle display, a voice or the like. At least one processor included in the main controller 370 or the cabin system 300 may perform the vein authentication algorithm based on the image. When the user information through the iris recognition matches the user information through the vein matching, payment can be completed.

As a specific example, when a price for at least one service (for example, fuel injection, parking fee, cost of using a car sharing service or the like) used by the user while driving a vehicle is calculated and the calculated price is requested to be paid, the view angle of the high-resolution narrow angle camera may be adjusted to the region of interest set for the hand, and the vein authentication algorithm may be performed based on the vein image acquired by the high-resolution narrow angle camera. When the user information through the iris recognition matches the user information through the vein matching, the requested amount can be paid.

As another example, a user's personal device (for example, smart phone, computer or the like) may receive a message for the payment request. In order to approve the received payment request, the user authentication request may be transmitted to at least one processor included in the main controller 370 or the cabin system 300 through the vehicle network or the 5G network. The user may complete the biometrics authentication through the in-vehicle biometrics authentication method, and at least one processor included in the main controller 370 or the cabin system 300 may transmit the authenticated result to the user's personal device through the vehicle network or the 5G network.

According to the above-described method, the wide angle camera and the high-resolution narrow angle camera for performing the biometrics authentication may be included in a structure installed inside a vehicle. For example, a specific structure may be included in the center of the dashboard of the vehicle, and the specific structure may include a fixing unit and an operation unit. The fixing unit may be positioned under the particular structure, and the wide angle camera may be at a position where the FOV may be secured in the fixing unit. The operation unit may be positioned above the specific structure, and the high-resolution narrow angle camera may be included in the operation unit to enable the view angle adjustment. The operation unit can rotate 360° with respect to a central point of a hemispherical shape, and can also rotate in up, down, left, and right directions. The structure may be included in a pop-up form on the dashboard in the vehicle. Alternatively, the structure may be configured as a separate device for performing the biometrics authentication.

### Example

FIG. 14 illustrates an example of an apparatus for performing in-vehicle biometrics authentication.

Referring to FIG. 14, an apparatus 1400 for performing in-vehicle biometrics authentication includes a memory 1421, a processor 1422, an interface unit 1423, a power supply unit 1424, and an imaging unit 1415 and 1425.

The memory 1421 is electrically connected to the processor 1422. The memory 1421 may store basic data for a unit, control data for controlling an operation of the unit, and input/output data. The memory 1421 may store data processed by the processor 1422. The memory 1421 may be configured in a hardware manner, and may be configured as at least one of a ROM, a RAM, an EPROM, a flash drive, and a hard drive. The memory 1421 may store various data for the overall operation of the apparatus 1400 for performing in-vehicle biometrics authentication, such as a program for processing or controlling the processor 1422. The memory 1421 may be integrated with the processor 1422. According to an example, the memory 1421 may be classified into sub-components of the processor 1422.

The interface unit 1423 may exchange signals with at least one electronic device provided in the vehicle 10 in a wired or wireless manner. The interface unit 1423 may exchange signals with at least one of the memory 1421, the processor 1422, the power supply unit 1424, and the imaging devices 1415 and 1425 in a wired or wireless manner. The interface unit 1423 may be implemented in at least any one of a communication module, a terminal, a pin, a cable, a port, a circuit, an element, and a device.

The power supply unit 1424 may supply power to the apparatus 1400 for performing in-vehicle biometrics authentication. The power supply unit 1424 may be supplied with power from a power source (for example, a battery) included in the vehicle 10, and may supply power to each unit of the apparatus 1400 for performing in-vehicle biometrics authentication.

The processor 1422 may be electrically connected to the memory 1421, the interface unit 1423, and the power supply unit 1424 to exchange signals. The processor 1422 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electric units for performing other functions.

The processor 1422 may be driven by a power supply provided from the power supply unit 1429. The processor 1422 may receive data, process data, generate a signal, and provide a signal while power is supplied by the power supply unit 1429.

The processor 1422 may receive information from other electronic devices in the vehicle 10 through the interface unit 1423. The processor 1422 may receive a control signal to other electronic devices in the vehicle 10 through the interface unit 1423.

The imaging devices 1415 and 1425 may include a first camera 1425 and a second camera 1415. The first camera 1425 and the second camera 1425 may have different angles of view. In addition, the first camera 1425 and the second camera 1425 may have different resolutions. The first camera 1425 may correspond to a wide angle camera capable of photographing the inside of the cabin as a whole to perform biometrics authentication. In detail, the first camera 1425 may support a field of view (FOV) of 130° or more and a resolution of 1920×720 (FHD) or more. The first camera 1425 may be a wide angle camera in which an RGB sensor and a depth sensor are combined to recognize a depth of a target to be photographed. The second camera 1415 may correspond to a high-resolution narrow angle camera for photographing a video or an image required for biometrics authentication. In detail, the second camera 1415 may support a FOV of 30° or more and a resolution of 4096×1716 (FHD) or more. The second camera 1415 may be configured as a stereo camera.

In addition, the apparatus 1400 for performing in-vehicle biometrics authentication may mechanically include an operation unit 1410 and a fixing unit 1420. The fixing unit 1420 may be positioned under the apparatus 1400 for performing in-vehicle biometrics authentication, and the operation unit 1410 may be positioned above the in-vehicle biometrics device. The operation unit can rotate 360° with respect to the central point of the hemispherical shape, and can also rotate in up, down, left, and right directions. The first camera 1425 may be positioned in the fixing unit 1420, and the second camera 1415 may be positioned in the operation unit 1410. The view angle of the second camera 1415 may be adjusted according to the up, down, left, and right rotation of the operation unit 1410.

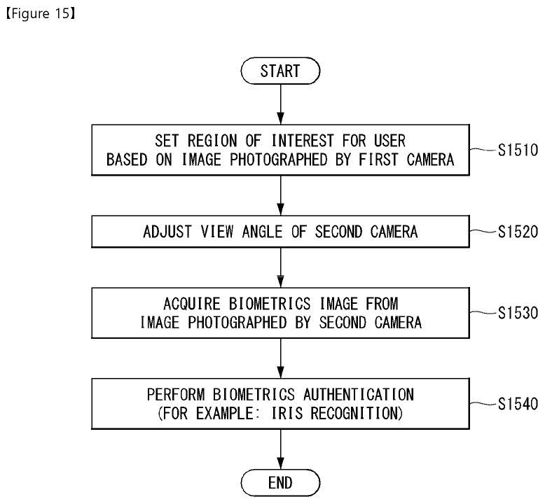

FIG. 15 illustrates an example of a flowchart in which the apparatus 1400 for performing in-vehicle biometrics authentication is operated. Hereinafter, with reference to FIG. 15, a detailed method of operating an apparatus 1400 for performing in-vehicle biometrics authentication will be described. The apparatus for performing in-vehicle biometrics authentication can be positioned on a in-vehicle dashboard, which is assumed and described. However, this is merely for convenience of description and does not limit the technical spirit of the present invention.

When the user is in the vehicle, the first camera 1425 may photograph the inside of the cabin as a whole. The image acquired by the first camera may be transmitted to the processor 1422 through the interface unit 1423. The processor may classify the number of users in the vehicle, positions of the users, a position of a biometrics information acquisition target such as the user's face and hand, from the image acquired by the first camera. The processor 1422 may set a position of at least one of the user's face and the hand as a region of interest based on the image acquired by the first camera (S1510). A region of interest for the face and the hand may be set simultaneously, a region of interest for the face may be set, and a region of interest for the hand may be additionally set when additional authentication such as a payment request is required. The region of interest may be set only for a driver, may be set for a user seated in a front seat of a vehicle, or may be set for all users in the vehicle. In addition, the region of interest may be updated by tracking the change in the region of interest as the user moves.

The processor 1422 may adjust the view angle of the second camera 1415 by controlling the operation unit 1410 based on the set region of interest (S1520). When a driver is authenticated, the view angle of the second camera may be adjusted to positions of driver's eyes by moving the operation unit to a region of interest set at a position of a driver's face. The second camera may acquire an image of a user's iris. An image acquired by the second camera may be transmitted to a processor through an interface unit (S1530).

The processor may perform an iris recognition algorithm based on the image acquired by the second camera (S1540). The information on the user subjected to the biometrics authentication through the iris recognition algorithm may be provided to at least one of the display system 350, the cargo system 355, the seat system 360, and the payment system 365, which are included in the cabin system 300, through the interface unit 1423. A service suitable for a user may be provided to a user who has successfully authenticated according to the examples of the autonomous scenario described above. On the other hand, re-authentication may be requested for a user who fails in authentication. Alternatively, information on a new user may be transmitted to an owner or a registered owner of a vehicle through a vehicle network or a 5G network, and authority setting for the new user may be transmitted and received.

When a payment related request is generated while driving or in a vehicle, the apparatus for performing in-vehicle biometrics authentication may perform additional biometrics authentication. The payment related request may be transmitted through the vehicle network as a payment related to a vehicle operation. Alternatively, an authentication request for payment may be transmitted from a user terminal connected to a vehicle. When the payment related request is generated, the processor may move an operation unit to adjust a view angle of the second camera to the position of the hand in order to perform additional biometrics authentication. Prior to this, the region of interest for the hand may be set using the first camera. Alternatively, this process may be omitted when the region of interest for the corresponding biometrics information is already set. That is, the interest regions for the face and the hand may be simultaneously set when the region of interest for user authentication is set even before the payment related request is generated. In this case, the step of setting the ROI for the hand after the payment request may be omitted. The second camera may photograph veins of a hand (for example, a finger, a back of a hand, a palm and the like) according to the adjusted view angle, and transmit the same to the processor. The processor may perform a vein authentication algorithm based on the received vein image. If the vein authentication information and the iris authentication information match with each other, the payment may be completed. If the authentication information does not match, a message for requesting re-authentication may be displayed.

Although the above-described embodiment is described in order of performing the iris recognition and additionally performing the vein matching, this is merely an example and does not limit the technical spirit of the present invention. Therefore, the matching may be performed and the iris recognition may be additionally performed

According to the above-described method and embodiment, it is possible to reduce costs, perform the biometrics for a plurality of passengers, and perform the biometrics without the special operation of the passengers by configuring the biometrics authentication system using the multi-camera in the vehicle.

The foregoing embodiments can be made by combining the structural elements and features of the present invention in various ways. Unless otherwise stated, each structural element or function may be optionally considered. Each of the structural elements or features may be performed without being combined with other structural elements or features. In addition, some structural elements and/or features may be combined with one another to implement the invention. A sequence of operations described in the implementation of the present invention may be changed. Some structural elements or features of one implementation may be included in another implementation or may be replaced by structural elements or features corresponding to another implementation.

The implementations in the present invention may be made by various technologies, such as hardware, firmware, software, or combinations thereof. In a hardware configuration, a method according to the implementation of the present invention may be made by one or more application specific integrated circuits (ASICs), one or more digital signal processors (DSPs), one or more digital signal processing devices (DSPDs), one or more programmable logic devices (PLDs), one or more field programmable gate arrays (FPGAs), one or more processors, one or more controllers, one or more microcontrollers, one or more microprocessors, and the like.

In the configuration of firmware or software, the implementations of the invention may be implemented in the form of modules, procedures, functions and the like. A software code may be stored in a memory and executed by a processor. The memory may be positioned inside or outside the processor, and may transmit and receive data from the processor in various ways.

### INDUSTRIAL APPLICABILITY

It will be apparent to those skilled in the art that various changes and modifications can be made in the present invention without departing from the spirit or scope of the invention. The present invention has been described with reference to an example applied to a 3GPP LTE/LTE-A system or a 5G system (or NR system), but is also applicable to various other wireless communication systems.

1. A method of performing biometrics authentication in a vehicle system, the method comprising:
setting a region of interest for a user in a vehicle based on an image photographed by a first camera;
adjusting a view angle of a second camera based on the region of interest;
acquiring an image required for biometrics for the user in the vehicle using the second camera; and
performing the biometrics authentication based on the image required for the biometrics,
wherein the region of interest is set for at least one of a face and a hand of the user in the vehicle.

2. The method of claim 1, wherein the image required for the biometrics corresponds to an image for an iris.

3. The method of claim 1, wherein the first camera corresponds to a wide angle camera which supports a field of view (FOV) of 130° or more, and the second camera corresponds to a high-resolution narrow angle camera which supports a resolution of ultra-high definition (UHD) or more.

4. The method of claim 1, wherein information on a user subjected to the biometrics authentication is provided to at least any one of a display system, a cargo system, a seat system, and a payment system included in the vehicle system.

5. The method of claim 1, further comprising:
acquiring another image required for the biometrics for the user in the vehicle using the second camera; and
performing additional biometrics authentication based on the another image.

6. The method of claim 5, wherein the another image corresponds to an image for a vein of the hand of the user in the vehicle.

7. The method of claim 5, wherein the additional biometrics authentication is performed when payment request signaling is received.

8. The method of claim 7, wherein when a result of the biometrics authentication is the same as a result of the additional biometrics authentication, payment for the payment request is completed.

9. An apparatus for performing biometrics authentication in a vehicle system, the apparatus comprising:
a memory for storing data;
an imaging device for capturing an image, the image device including a first camera and a second camera; and
a processor functionally connected to the memory and the imaging device, wherein the processor controls to:
set a region of interest for a user in a vehicle based on an image captured by a first camera,
adjust a view angle of the second camera based on the region of interest,
acquire an image required for biometrics for the user in the vehicle using the second camera, and
perform the biometrics authentication based on the image required for the biometrics,
wherein the region of interest is set for at least one of a face and a hand of the user in the vehicle.

10. The apparatus of claim 9, wherein the first camera corresponds to a wide angle camera which supports a field of view (FOV) of 130° or more, and the second camera corresponds to a high-resolution narrow angle camera which supports a resolution of ultra-high definition (UHD) or more.

11. The apparatus of claim 9, wherein the processor further controls to:
acquire another image required for biometrics for the user in the vehicle using the second camera, and
perform additional biometrics authentication based on the another image.

12. The apparatus of claim 11, wherein the image required for the biometrics corresponds to an image for an iris, and
the another image corresponds to an image for a vein of the hand of the user in the vehicle.

13. The apparatus of claim 11, wherein the additional biometrics authentication is performed when the processor receives payment request signaling in the vehicle.

14. The apparatus of claim 13, wherein when a result of the biometrics authentication is the same as a result of the additional biometrics authentication, the processor performs control to complete payment for the payment request.

15. The apparatus of claim 9, wherein the apparatus communicates with at least one of a mobile terminal, a network, and an autonomous vehicle other than the apparatus.
